(19) United States
(12) Patent Application Publication
(10) Pub. No.: US 2004/0192216 A1
(43) Pub. Date: Sep. 30, 2004

(54) Training for MIMO communication systems

(76) Inventors: Thomas Louis Marzetta, Summit, NJ (US); Raman C. Venkataramani, Somerset, NJ (US)

Correspondence Address: Ryan, Mason & Lewis, LLP, Suite 205, 1300 Post Road, Fairfield, CT, 06430, US

(21) Appl. No.: 10/404,011

(22) Filed: Mar. 31, 2003

(51) Int. Cl. H04B 17/00

(52) U.S. Cl. 455/67.14; 455/423

(57) ABSTRACT

Training is performed to characterize one or more communication channels between a first communication unit (CU) and one or more additional CUs. Channel characteristic(s) are determined by using first training signals received by the first CU from one of the additional CUs. Second training signals, defined at least in part by the channel characteristic(s), are determined. The channel characteristic(s) may comprise a unitary factor and power levels for subchannels. The second training signals are transmitted from the first CU to the one additional CU, which not only determines characteristics of the channel but also usually determines scheduling information. Each CU independently determines communication rates on subchannels. Typically, the two communication rates will be in agreement. The one additional CU sends modified training signals so that the first CU lowers the communication rate on subchannels.

### FIELD OF THE INVENTION

The present invention relates generally to communication over wireless networks, and, more particularly, to communication between multiple input multiple output (MIMO) communication units on wireless networks.

### BACKGROUND OF THE INVENTION

Multiple input, multiple output (MIMO) communication systems generally comprise two or more communication units, each unit having an array of multiple antennas. With MIMO communication systems, it is possible to separately send a different signal into each transmit antenna and, at the receive end, measure independently the signal that comes out of each receive antenna. Assuming that propagation conditions are favorable, the throughput of a MIMO communication system increases with the number of antennas. This increase in throughput comes without a corresponding increase in power or bandwidth.

With most communication systems, communication between two communication units is better when there is a clear line-of-sight propagation between the two communication units. However, clear line-of-sight propagation is less desirable for MIMO communication systems. In fact, more complicated scattering can lead to improved results in a MIMO communication system. A communication between two MIMO communication units occurs through a communication channel. A channel propagation matrix can be estimated that describes this communication channel. The propagation matrix therefore is related, to some degree, to the scattering that occurs in the communication channel.

Knowledge of the channel propagation matrix is important, as this knowledge of this matrix is used to separate information communicated over the communication channel. For instance, a receive antenna receives some linear combination of signals from all transmit antennas. Knowledge of the channel propagation matrix is used to decipher this linear combination of signals. In many MIMO communication systems, it is assumed that only the receiver has knowledge of the channel propagation matrix. A communication unit estimates the channel propagation matrix through a training process, where known signals, called “training signals” herein, are sent over the communication channel between two communication units.

There has been some research into having the communication units at the two “ends” of a communication channel estimate the channel propagation matrix. When both communication units know the channel propagation matrix, a complex communication channel can be greatly simplified through known techniques that render the channel propagation matrix primarily as a diagonal matrix. Nonetheless, some researchers believe that it is too time consuming for both ends of a communication channel to estimate the channel propagation matrix and thereby estimate channel characteristics.

A need therefore exists for techniques that allow two or more communication units, communicating via a communication channel, to efficiently estimate characteristics of the communication channel.

### SUMMARY OF THE INVENTION

The present invention provides techniques for training for multiple input, multiple output (MIMO) communication systems.

In a first aspect of the invention, training is performed in a MIMO communication system in order to characterize one or more communication channels between a first communication unit and one or more additional communication units. One or more channel characteristics are estimated at the first communication unit by using first training signals received by the first communication unit from one of the additional communication units. Second training signals, defined at least in part by the one or more channel characteristics, are determined by the first communication unit. The second training signals are transmitted from the first communication unit to the one additional communication unit.

Illustratively, by defining the second training signals at least in part by channel characteristics, a communication unit (e.g., the one additional communication unit) receiving the second training signals may not only estimate characteristics of the communication channel but may also determine scheduling information, such as power levels that may be used when transmitting on, for instance, two or more antennas coupled to the communication unit.

The second training signals may be defined by a unitary factor, determined by a factorization of an estimate for a channel propagation matrix that is itself defined by at least the first training signals. The unitary factor is a channel characteristic. The second training signals may also be defined by values for power levels to be transmitted on one or more subchannels of the communication channel. The power levels to be transmitted per subchannel are characteristics of the communication channel and are generally determined by the first communication unit. One of the benefits of the training is to enable the two units jointly to diagonalize the channel, rendering it in the form of parallel, independent subchannels. Generally, if there are M transmitting antennas and N receiving antennas in communication via a communication channel, there are min(M, N) subchannels.

The first communication unit and the one additional communication unit may also independently schedule communication rates to be used for subchannels. Furthermore, the two independently scheduled communication rates will agree with one another with high likelihood. Each communication unit makes an estimate of capacity of each subchannel. The estimated capacity may be quantized in order to determine a communication rate that may be used per subchannel.

The first communication unit may communicate with multiple additional communication units, such as through a one-to-many MIMO communication system. Each of the multiple additional communication units generally sends first training signals to the first communication unit. The first communication unit generally determines multiple sets of training signals, one set for each of the multiple additional communication units. The sets of second training signals are transmitted from the first communication unit to the multiple additional communication units.

In an additional aspect of the invention, training is performed in a MIMO communication system to characterize one or more communication channels between a first communication unit and one or more additional communication units. A number of first training signals are transmitted from one of the additional communication units to the first communication unit. A number of second training signals are received at the one additional communication unit, where the second training signals are defined at least in part by one or more channel characteristics estimated by the first communication unit by using at least the first training signals.

The first communication unit and the one additional communication unit may each be adapted to transmit and receive over a number of subchannels. The one additional communication unit may factor a matrix defined at least in part by the plurality of second training signals. The step of factoring may determine one or more terms. One of the terms may be a term defining received powers of one or more of the subchannels, and the received powers may be used when decoding signals on the subchannels.

The first communication unit may assume a nominal noise variance for reception at the one additional communication unit. The one additional communication unit, when it determines that an actual noise variance is greater then the nominal noise variance, can modify the first training signals sent from the one additional communication unit to the first communication unit. Generally, the one additional communication unit defines first training signals having predetermined properties, such as power levels, amplitude, and number of training signals. The first communication unit expects training signals having the predetermined properties. The modification by the one additional communication unit may comprise, for example, scaling the training signals, changing the power levels allotted to the training signals, or both. When the first communication unit receives the modified training signals, the first communication unit generally reduces the communication rate for one or more subchannels.

### BRIEF DESCRIPTION OF THE DRAWINGS

FIG. 1 is a block diagram of a prior art multiple input, multiple output (MIMO) communication system, used to describe a forward link model;

FIG. 2 is a block diagram of a prior art MIMO communication system, used to describe a reverse link model;

FIG. 3 is a block diagram of a one-to-one MIMO communication system for training and scheduling MIMO communication units, in accordance with a preferred embodiment of the invention;

FIG. 4 is a flowchart of a method for training and scheduling two MIMO communication units communicating over a communication channel, in accordance with a preferred embodiment of the invention;

FIG. 5 is a flowchart of a method for changing power levels, communication rates or both for two MIMO communication units communicating over a communication channel, in accordance with a preferred embodiment of the invention;

FIG. 6 is an exemplary rate scheduling curve used by two or more MIMO communication units communicating over a communication channel, in accordance with a preferred embodiment of the invention;

FIG. 7 is a block diagram of a one-to-many MIMO communication system for training and scheduling MIMO communication units, in accordance with a preferred embodiment of the invention; and

FIG. 8 is a flowchart of a method for training and scheduling between a base station and multiple users, in accordance with a preferred embodiment of the invention.

### DETAILED DESCRIPTION

For ease of reference, the present disclosure is divided into the following sections: Introduction; Training and Scheduling for a One-to-One Multiple Input, Multiple Output (MIMO) Communication System; and Training and Scheduling for a One-to-Many MIMO Communication System.

Introduction

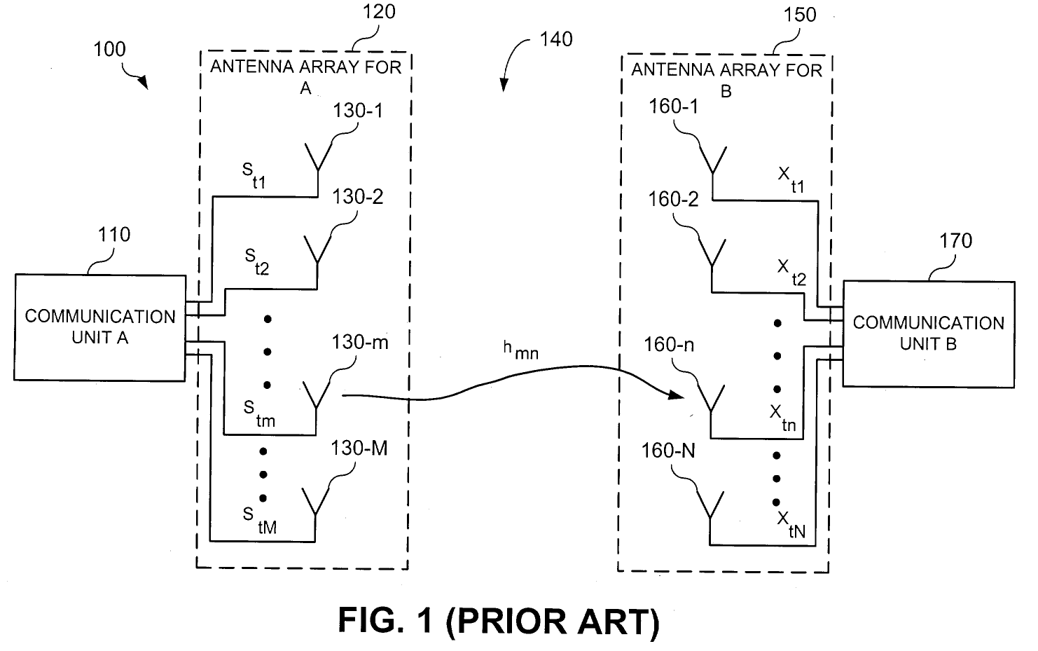

Referring now to FIG. 1, a prior art MIMO communication system 100 is shown. In this example, a communication unit A 110 couples M transmit signals Sₜ₁ through S_{tM} to M antennas 130-1 through 130-M in a antenna array 120. The transmit signals Sₜ₁ through S_{tM} are communicated simultaneously to the antenna array 150 via the communication channel 140. Throughout the present disclosure, it is assumed that a complex baseband representation for transmitted and received signals is used. Each of the N antennas 160-1 through 160-N receives a linear combination of the transmit signals Sₜ₁ through S_{tM}, as modified by the communication channel 140, and creates one of the receive signals Xₜ₁ through X_{tN}, respectively. The receive signals Xₜ₁ through X_{tN} are coupled to the communication unit B 170.

Each of the communication unit A 110 and communication unit B 170 is able to both transmit and receive signals, but for purposes of illustration transmission from communication unit A 110 to communication unit B 170 is considered via a forward link model. When there are M transmitting antennas and N receiving antennas, there are min(M, N) subchannels in the communication channel 140.

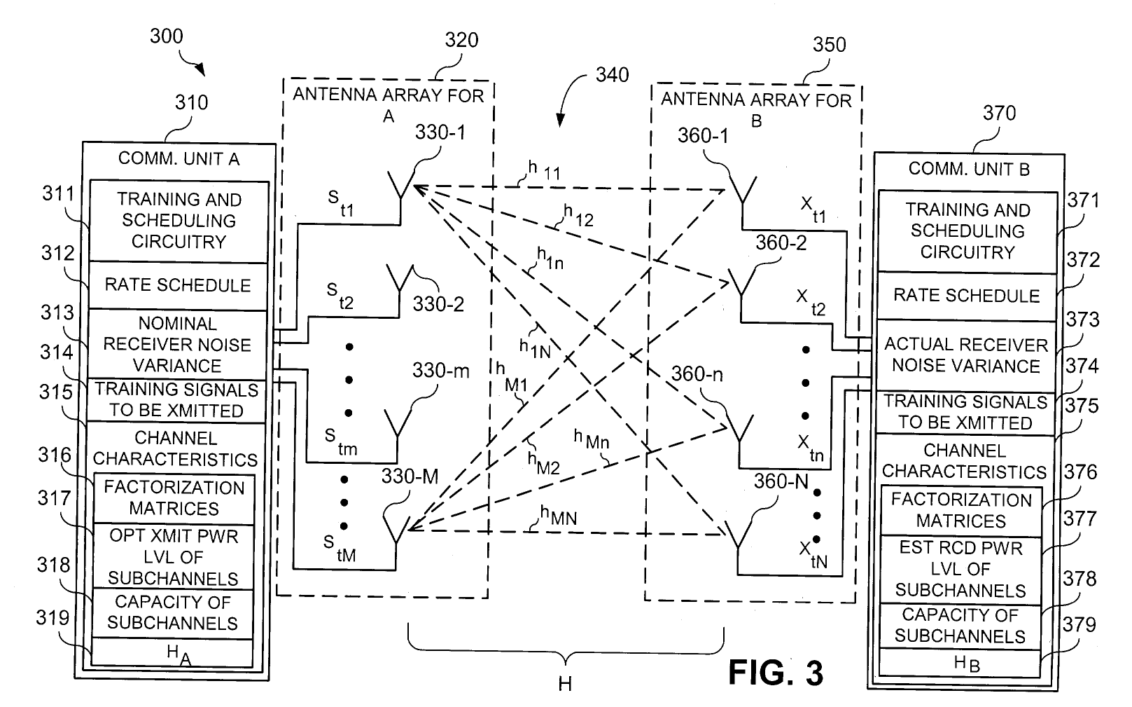

A mathematical model of MIMO communication system 100 of FIG. 1 is as follows. Assume M≧N and that there is flat fading with a coherence interval of T symbols, where T>>1. Flat fading implies that the channel propagation matrix (denoted by H below and defined in more detail in reference to FIG. 3) is approximately constant with respect to frequency over the bandwidth of the transmitted signal.

The following are written in matrix notation, with notes to describe this notation: there are M transmit signals during a time period, written as Sₜ: 1×M; there are N receive signals during a time period, written as Xₜ: 1×N; there are N noise signals, written as Wₜ: 1×N; and H is the channel propagation matrix, written as H:M×N. Subsequent use of matrix notation will not be annotated. The received signals are Xₜ=SₜH+Wₜ and the noise signals are Wₜ. Throughout, it is assumed that the noise is uncorrelated from one receiver to another and typically of equal average power, σ_{B}². The MIMO communication system 100 of FIG. 1 is subject to the power constraint of E∥Sₜ∥²≦1, that is the total average transmit power is less than or equal to one. Choosing one as the limit on power is done for simplicity of discussion and incurs no loss of generality.

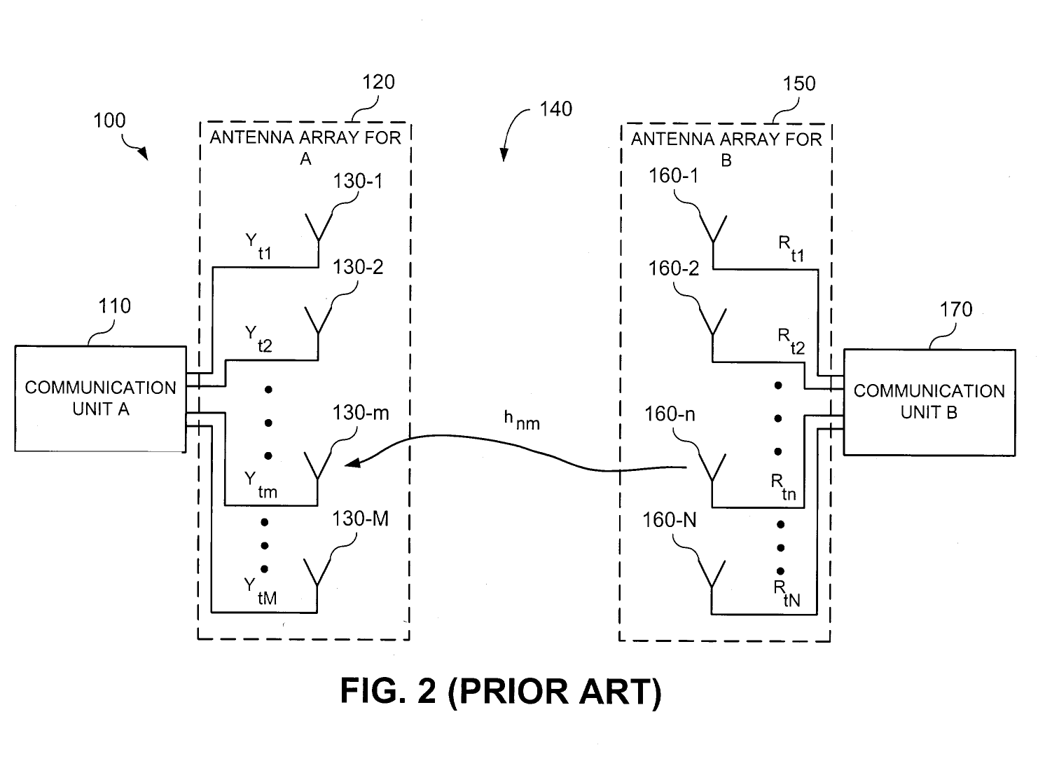

Turning now to FIG. 2, the MIMO communication system 100 of FIG. 1 is shown in the reverse link direction, where the communication unit 170 transmits N transmit signals Rₜ:1×N, which are coupled to and transmitted via the antenna array 160-1 through 160-N. After the transmit signals propagate through the communication channel 140, each of the M antennas 130-1 through 130-M receives a linear combination of the transmit signals Rₜ, as modified by the communication channel 140, and creates one of the receive signals Yₜ:1×M. The receive signals Yₜ are coupled to the communication unit A 110.

A mathematical model of MIMO communication system 100 of FIG. 2 is as follows. The received signals are Yₜ=RₜH^{T}+Vₜ and the noise signals, Vₜ:1×M. Throughout, it is assumed that the noise is uncorrelated from one receiver to another and typically of equal average power, σ_{A}². The MIMO communication system 100 of FIG. 2 is subject to the power constraint of E∥Rₜ∥²≦1. Choosing one as the limit on power is done for simplicity of discussion and incurs no loss of generality.

In general, the channel propagation matrix that characterizes propagation from communication unit A 110 to communication unit B 170 will not be directly related to the channel propagation matrix that characterizes propagation from communication unit B 170 to communication unit A 110. The channel propagation matrices are generally different because the carrier frequencies at which each communication unit 110, 170 transmits are usually quite different. Nonetheless, there are times when the channel propagation matrices estimated by communication units 110, 170 for the forward link model of FIG. 1 and the reverse link model of FIG. 2 will be very similar or identical. The channel propagation matrices should be approximately the same when there is reciprocity.

When there is reciprocity, the values of the channel propagation matrix H by the communication unit B 170 in the transmission of FIG. 1 and the values of propagation matrix H by the communication unit A 110 in the transmission of FIG. 2 will be directly related and therefore the two estimates should be similar (e.g., the propagation matrices are transposes of each other). Reciprocity generally holds when both the communication unit A 110 and the communication unit B 170 transmit and receive using carrier frequencies that are approximately equal. By way of illustration, if the carrier frequency used by communication unit A 110 to transmit to communication unit B 170 is f_{A} and the carrier frequency used by communication unit 170 to transmit to communication unit A 110 is f_{B}, then reciprocity should occur when |f_{A}−f_{B}|<f_{R}, where f_{R} is a relatively small frequency range. It is well known that f_{R} is typically less than the reciprocal of the delay-spread of the channel.

Reciprocity allows both communication units at each end of a communication channel to estimate similar characteristics about the communication channel. Advantages of having communication units at each end of a communication channel being able to estimate characteristics, such characteristics defined by a channel propagation matrix, of the communication channel include the following: (1) encoding and decoding are simple; and (2) there is a seamless transition from Rayleigh fading to specular propagation. A disadvantage is the extra training required in order for the communication units at each end of a communication channel to estimate characteristics about the communication channel. Having communication units at each end of a communication channel estimate characteristics about the communication channel is generally feasible in a flat fading environment, but may be performed in other environments.

The capacity of a known communication channel between a communication unit A and a communication unit B will now be reviewed. It is assumed that the communication unit A is the communication unit responsible for determining power levels and communication rates to place on each subchannel. For the channel propagation matrix, H, let H=αΛβ^{†} be a singular value decomposition (SVD) of H, where:

α:M×N, α^{†}α=I_{N}, where I_{N} is the N×N identity matrix,

β:N×N, β^{†}β=I_{N},

Λ:N×N, Λ=diag(λ₁, . . . , λ_{N}),

where the terms α and β are referred to as unitary factors herein, Λ is referred to as a channel diagonal matrix herein, the λ are referred to as singular values herein and are always real and non-negative, and the “†” means “complex conjugate transpose.” Then, the received signals at (e.g., at communication unit B) are the following:

Xₜ=SₜαΛβ^{†}+Wₜ,

subject to the power constraint of E∥Sₜ∥²≦1, where Sₜ are transmitted signals (e.g., transmitted by communication unit A), and where the Wₜ are noise signals at the receiver (e.g., communication unit B).

Let Sₜ=Aₜα^{†}, \tilde{X}ₜ=Xₜβ, and \tilde{W}ₜ=Wₜβ. Then

\tilde{X}ₜ=AₜΛ+\tilde{W}ₜ,

which means that the channel propagation matrix, H, has been diagonalized. The operation of diagonalizing the channel propagation matrix is commonly called “diagonalizing the communication channel.” This diagonalization is a no-cost transformation because ∥Aₜ∥²=∥Sₜ∥² and there is little or no change in typical white receiver noise power due to the diagonalization.

Choose Aₜ˜CN(0, P), where P=diag(P₁, . . . , P_{N}), to attain capacity:

$$C = {\sum }_{n = 1}^{N} {C}_{n} = {\sum }_{n = 1}^{N} log ( 1 + \frac{{P}_{n} {λ}_{n}^{2}}{{σ}_{B}^{2}} ) ,$$

where Cₙ is the capacity on the n-th subchannel, Pₙ is the power level on the n-th subchannel, λₙ is the singular value for the n-th subchannel, and σ_{B} is the noise variance at the communication unit B. The optimal power levels {Pₙ} are chosen by the well known water filling rule:

$${P}_{n} = {( μ - \frac{{σ}_{B}^{2}}{{λ}_{n}^{2}} )}^{+} such that {\sum }_{n = 1}^{N} {P}_{n} = 1 ,$$

where the superscript “+” indicates that when the quantity in parenthesis is less than zero, the expression is set equal to zero, and where μ is a parameter that is chosen to satisfy the power constraint. It will later be shown that it is sometimes beneficial for communication unit A to make modifications to these optimal powers. It is to be noted that capacity is achievable by independent coding on the virtual subchannels, but joint coding will give a smaller error probability, albeit with extra effort. It should be noted that the singular values, λₙ, provide an indication of what values for power levels should be placed on the subchannels. For instance, subchannels having large singular values should generally have higher power levels placed on the subchannels. Nonetheless, it is the water filling process that determines optimal power levels to be placed on a subchannel. It may be sometimes advantageous to depart from these optimal powers.

A naïve approach for training two communication units in order to estimate channel propagation matrices is as follows. When transmitting from communication unit A to communication unit B, communication unit A sends orthonornal training signals over T_{A}≧M symbols, where the symbols are S=\sqrt{T_{A}}Φ, and where Φ^{†}Φ=I. Then, communication unit B receives X=\sqrt{T_{A}}ΦH+W [symbol] H_{B}=Φ^{†}X/\sqrt{T_{A}}≅H.

As part of the naïve approach, when transmitting from communication unit B to communication unit A, communication unit B sends orthonormal training signals over T_{B}≧M, where the symbols are R=\sqrt{T_{B}}Ψ, and where Ψ^{†}Ψ=I. Communication unit A receives Y=\sqrt{T_{B}}ΨH^{T}+V [symbol] H_{A}=(Ψ^{†}X)^{T}/\sqrt{T_{B}}≅H.

The total training time is then T_{A}+T_{B}≧M+N.

There are certain problems with this naive approach. First, both communication unit A and communication unit B obtain estimates for the full channel propagation matrix, which is more information than they need for implementing the SVD. Second, the SVD unitary factors are non-unique, which is proven as follows. Suppose H=αΛβ^{†} and D=diag(e^{jφ1}, . . . ,e^{jφN}) is arbitrary. Then, αDΛD^{†}β^{†}=αΛβ^{†}=H. Thus, αD and βD are valid unitary factors. It is possible to force the top row of the unitary factor α to have real positive entries. Nonetheless, this is prone to errors when the values of these entries are small. Coincident singular values means that there are non-unique SVD unitary factors. What this means is that communication unit A and communication unit B cannot properly diagonalize the communication channel if their SVD factors do not agree.

Training and Scheduling for a One-to-One Multiple Input, Multiple Output (MIMO) Communication System

The present invention provides, among other things, training techniques for efficiently having each end of a communication channel learn characteristics of the communication channel, generally as defined by channel propagation matrices. In one aspect of the invention, the training techniques used for allowing each end of a communication channel to learn the channel propagation matrix are performed so that the singular value decomposition (SVD) unitary factors and singular values are unique. Furthermore, in certain aspects of the invention, training techniques also allow scheduling to occur to some extent at the same time as training. For instance, a communication unit can determine power levels, to be placed on subchannels, by using specially designed training signals received from another communication unit. Power levels are generally scheduled through transmissions between communication units, where the transmissions are performed solely to provide power level scheduling. Conversely, in aspects of the present invention, the power levels may be determined through the use of training signals defined in part by power levels to be placed on subchannels. The term “training signals” as used herein is intended to include, by way of example, pilot signals.

In an aspect of the invention, one additional communication unit sends first training signals to a first communication unit. The first communication unit uses the first training signals to estimate channel characteristics. The first communication unit determines second training signals defined, at least in part, by channel characteristics and transmits the second training signals to the one additional communication unit. One exemplary channel characteristic is a unitary factor that the first communication unit determines from a factorization of the channel propagation matrix the first communication unit estimates. The factorization may be performed, for instance, through an SVD. A second exemplary channel characteristic is the power level the first communication unit determines should be placed on each subchannel. The power level to be placed on each subchannel is a function of the singular values determined from the SVD of the channel propagation matrix, and is therefore a characteristic of the communication channel. For instance, subchannels corresponding to singular values that have larger values can have higher power levels placed on the subchannels. Conversely, subchannels corresponding to singular values that have smaller values can have lower power levels placed on the subchannels. It should be noted that the power level to be placed on each channel will generally meet certain criteria, such as a power constraint (e.g., power levels on all subchannels should be less than or equal to the available transmission power). Consequently, even though a subchannel may be able to support a particular maximum power level, a communication unit may decide to place either a lower or a higher power level on this subchannel than the maximum power level.

Moreover, additional scheduling may be performed by having both communication units at the two ends of a communication channel know a particular rate scheduling curve. Using a quantizer, each communication unit can assume communication rates to be placed on subchannels. In another aspect of the invention, a first communication unit making a determination as to power levels to place on subchannels can assume a nominal noise variance for a second communication unit. If the second communication unit determines that its true noise variance is greater than the nominal noise variance, for example due to interference, the second communication unit can modify training symbols sent to the first communication unit. The modification can comprise scaling the training symbols or using reduced power levels for the training symbols. Generally, the second communication unit defines training signals have predetermined properties, such as power level, amplitude, and number of training signals. The first communication unit expects training signals having the predetermined properties. The first communication unit, after receiving the modified training signals, will then assume that the communication channel is weaker than it really is, which causes the first communication unit to estimate smaller capacities than otherwise and therefore to transmit at smaller rates.

Additionally, in other aspects of the invention, a one-to-one MIMO communication system may be used or a one-to-many MIMO communication system may be used. An exemplary one-to-one MIMO communication system is described in this section and an exemplary one-to-many MIMO is described in the next section.

Turning now to FIG. 3, a MIMO communication system 300 is shown operating in accordance with an embodiment of the present invention. The MIMO communication system 300 comprises two communication units 310, 370 that are communicating through a communication channel 340 via antenna arrays 320, 350. The communication unit A 310 comprises training and scheduling circuitry 311, a rate schedule 312, a nominal receiver noise variance 313, training symbols 314, and a number of channel characteristics 315. Channel characteristics 315 comprise factorization matrices 316 (e.g., α_{A}, Λ_{A}, β_{A}, as described in additional detail below), optimal transmit power levels of subchannels 317, capacity of subchannels 318, and a channel propagation matrix 319 (e.g., H_{A}). The communication unit B 370 comprises training and scheduling circuitry 371, a rate schedule 372, an actual receiver noise variance 373, training symbols 374, and a number of channel characteristics 375. Channel characteristics 375 comprise factorization matrices 376 (e.g., α_{B}, Λ_{B}, β_{B}, as described in additional detail below), estimated received power levels of subchannels 377, capacity of subchannels 378, and a channel propagation matrix 379 (e.g., H_{B}),

Communication unit A 310 is coupled to an antenna array 320, comprising antennas 330-1 through 330-M. Communication unit A 310 can receive or transmit M signals via the M antennas 330-1 through 330-M in antenna array 320. Similarly, communication unit B 370 is coupled to an antenna array 350, comprising antennas 360-1 through 360-N. Communication unit B 370 can receive or transmit N signals via the N antennas 360-1 through 360-N in antenna array 350.

The channel propagation matrix, H, comprises a number of entries, each entry corresponding to a propagation coefficient between an antenna 330 and an antenna 360. In FIG. 3, exemplary propagation coefficients are shown between antenna 330-1 and antennas 360-1, 360-2, 360-n, and 360-N and also between antenna 330-M and antennas 360-1, 360-2, 360-n, and 360-N.

The training and scheduling circuitry 311 and training and scheduling circuitry 371 cooperate to train both the communication units 310, 370 and to schedule power levels and capacity for each of the subchannels on the communication channel 340. As previously described, for M transmit antennas and N receive antennas, there are min(M, N) subchannels. Examples of “one-way” training techniques, for training signals sent from a first to a second communication unit but where reciprocity is not used, can be found in U.S. Pat. No. 6,307,882, issued Oct. 23, 2001 in the name of inventor T. Marzetta and entitled, “Determining Channel Characteristics in a Space-Time Architecture Wireless Communication System Having Multi-Element Antennas,” the disclosure of which is hereby incorporated by reference.

The training and scheduling circuitry 311 directs the communication unit A 310 in order to train the communication units 310, 370 and estimate channel characteristics 315. The training and scheduling circuitry 311 can determine the channel propagation matrix 319 from training signals 374 transmitted from communication unit B 370 and received by communication unit A 310. The channel propagation matrix 319 estimates properties of the channel 340. The training and scheduling circuitry 311 can factor the channel propagation matrix 319 to create the factorization matrices 316. Using the factorization matrices 316, the optimal transmit power levels of subchannels 317 may be determined. Additionally, the capacity of subchannels 318 may be determined by using certain of the channel characteristics 315 and the optimal transmit power levels of subchannels 317. The transmission rates are determined by the rate schedule 312.

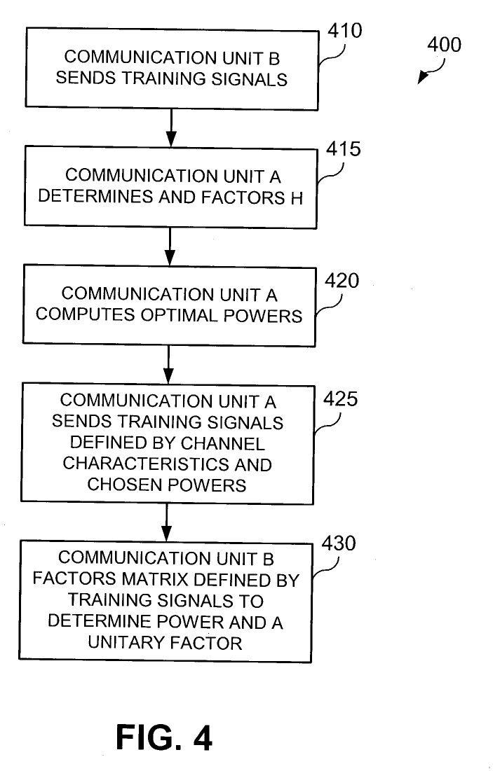

The training symbols 314 are determined by the training and scheduling circuitry 311 and, when transmitted by communication unit A 310 and received by communication unit B 370, provide the communication unit B 370 with, in one embodiment of the present invention, estimates of a unitary factor from a factorization of the channel propagation matrix 379 and estimated received power levels of subchannels 377. This is described in greater detail in reference to FIG. 4.

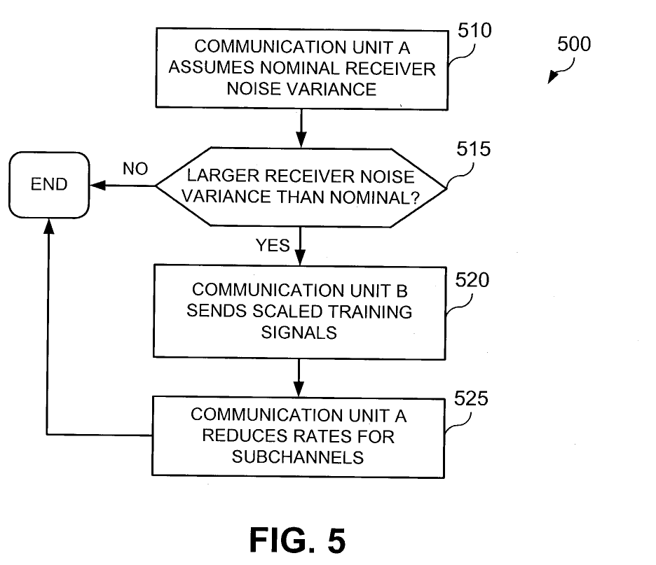

The training and scheduling circuitry 311 uses the nominal receiver noise variance 313 (along with other variables, as described in reference to FIG. 4) to determine optimal transmit power levels of subchannels 317. The nominal receiver noise variance 313 is an estimate of the noise variance at communication unit B 370 when the communication unit B 370 is used as a receiver. The nominal receiver noise variance 313 may be determined initially by the communication unit A 310, entered by a system administrator, or entered through some other technique. As described in reference to FIG. 5, the communication unit B 370 can determine that the actual receiver noise variance 373 is greater than the nominal receiver noise variance 313. When this occurs, the training and scheduling circuitry 371 can modify the training signals 374, communicated from the communication unit B 370 to the communication unit A 310. The modification can include scaling training signals 374, reducing power levels used to transmit the training signals 374, or both. The modification has the effect of making the training and scheduling circuitry 311 determine that the communication channel 340 is weaker than it is. The training and scheduling circuitry 311 has stored properties (not shown) of unmodified training signals 374, so that the training and scheduling circuitry 311 knows what the unmodified training signals 374 should be. The training and scheduling circuitry 311 then should reduce the communication rates allocated to the subchannels.

It is also possible for communication unit B 370 to communicate the actual receiver noise variance 373 to the communication unit A 310. For example, the uplink traffic channel could be used to communicate the actual receiver noise variance 373.

The training and scheduling circuitry 371 directs the communication unit A 370 in order to train the communication units 310, 370 and determine channel characteristics 375. The training and scheduling circuitry 371 can determine the channel propagation matrix 379 from training signals 315 transmitted from communication unit B 370 and received by communication unit A 310. The training and scheduling circuitry 371 can factor the channel propagation matrix 379 to create the factorization matrices 376. Using the factorization matrices 376, the estimated received power levels of subchannels 377 may be determined, and the received power levels of subchannels 377 may be used to decode received signals 360-1 through 360-N. Additionally, the capacity of subchannels 378 may be determined by using certain of the channel characteristics 375 and the estimated received power levels 377. The transmission rates are determined by the rate schedule 372.

Thus, the training and scheduling circuitry 311, 371 cooperate to train the communication units 310, 370 in order to enable the communication units 310, 370 to determine the channel characteristics 315, 375. The power levels and capacity of the subchannels may also be determined.

The training and scheduling circuitry 311, 371 may be implemented as circuitry, as shown in FIG. 3, or may be implemented as software or a combination of software and hardware. For instance, the training and scheduling circuitry 311, 371 could be executed by loading portions or all of a software module containing instructions suitable for implementing steps performed by training and scheduling circuitry 311, 371 into a processor (not shown) in communication units 310, 370. It is to be understood that the communication units 310, 370 also comprise memory (not shown) for holding the rate schedules 312, 372, receiver noise variances 313, 373, training symbols 314, 374, and channel characteristics 315, 375.

It is to be understood that the communication units 310, 370 may contain other elements that are not shown and that perform any necessary modulation, demodulation, amplification, and any other manipulation used to transmit or receive signals. These elements may be included the receive and transmit circuitry of the present invention. For instance, the circuitry shown in U.S. Pat. No. 6,058,105, issued May 2, 2000 in the names of inventors B. Hochwald and T. Marzetta and entitled, “Multiple Antenna Communication System and Method Thereof,” the disclosure of which is hereby incorporated by reference, may be used herein.

In order to understand the training techniques recommended herein, it is helpful to make some observations. Recall that the rotations Sₜ=Aₜα^{†} and \tilde{X}ₜ=Xₜβ diagonalize the communication channel \tilde{X}ₜ=AₜΛ+\tilde{W}ₜ, where Aₜ˜CN(0, P).

As described above, the capacity, C, and optimal power levels, {Pₙ}, are as follows:

$$C = {\sum }_{n = 1}^{N} {C}_{n} = {\sum }_{n = 1}^{N} log ( 1 + \frac{{P}_{n} {λ}_{n}^{2}}{{σ}_{B}^{2}} )$$

$${P}_{n} = {( μ - \frac{{σ}_{B}^{2}}{{λ}_{n}^{2}} )}^{+} such that {\sum }_{n = 1}^{N} {P}_{n} = 1.$$

An observation may be made that communication units A and B need not learn the channel propagation matrix H, completely. In fact, communication unit A, in general, needs to know only the unitary factor α, the receiver noise variance σ_{B}, and the diagonal matrix Λ (P depends on σ_{B} and Λ). Communication unit B, in general, needs to know only the unitary factor β and a diagonal power and singular value matrix, Γ^{def}=PΛ². This limited amount of knowledge for each of the communication units A and B is used below to provide efficient training and scheduling in accordance with certain aspects of the present invention.

Referring now to FIG. 4, a method 400 is shown for training and scheduling two MIMO communication units communication over a communication channel, in accordance with a preferred embodiment of the invention. Communication units A and B, for instance through respective ones of the training and scheduling circuitries 311, 371, cooperate to perform method 400. Method steps in method 400 are marked as to which step is preferably performed by which communication unit.

Method 400 begins in step 410 when communication unit B sends communication unit A orthonormal training signals of length T_{B}≧N and communication unit A computes an estimate of the channel propagation matrix, H, as H_{A}≅H (step 415). Also in step 415, the communication unit A factors H_{A}, preferably through an SVD: H_{A}=α_{A}Λ_{A}β_{A}^{†}, where Λ_{A}=diag(λ_{A1}, . . . λ_{AN}).

In step 420, communication unit A computes the optimal power levels using, for instance, a water filling rule:

$${P}_{n} = {( μ - \frac{{σ}_{B}^{2}}{{λ}_{n}^{2}} )}^{+} such that {\sum }_{n = 1}^{N} {P}_{n} = 1.$$

It is assumed that communication unit A knows the actual receiver noise variance, σ_{B}², such as through a communication from communication unit B to communication unit A of the actual receiver noise variance. However, FIG. 5, described below, shows a method where communication unit A need not know the actual receiver noise variance and, instead, can estimate or rely on a nominal receiver noise variance.

In step 425, communication unit A sends training signals defined at least in part by channel characteristics and chosen powers. For instance, the training signals, S, may be \sqrt{T_{A}}Ψ\sqrt{P}α_{A}^{†}, where the number of training signals is greater than the number of antennas at communication unit B, T_{A}≧N, Ψ is an optional unitary matrix that increases the training interval and therefore the effectiveness of the training, and is for example T_{A}×N, where Ψ^{†}Ψ=I, and P is a diagonal matrix determined via the water filling rule in step 420. It is assumed that both sides (i.e., communication units A and B in this example) know the factor, Ψ. The training signals, S, are then at least partially defined by channel characteristics. The unitary factor, α_{A}^{†}, is a channel characteristic determined by the SVD of H_{A}. Each of the power levels in the power matrix, P, is determined via the water filling rule. As shown above, each of the power levels, Pₙ, determined via the water filling rule depends on a corresponding singular value, λₙ which is a characteristic of the communication channel and is determined through the SVD on H_{A}.

The power constraint is met as follows:

$$\frac{1}{{T}_{A}} tr ( {SS}^{†} ) = tr ( P ) = 1.$$

Communication unit B receives the following:

$$X = SH + W = \sqrt{{T}_{A}} Ψ \sqrt{P} {α}_{A}^{†} H + W \\ = \sqrt{{T}_{A}} Ψ \sqrt{P} {Λβ}_{A}^{†} + noise terms$$

[symbol] Ψ^{†}X=\sqrt{T_{A}}\sqrt{Γ}β_{A}^{†}+ noise terms Note that α_{A}^{†}H=α_{A}^{†}α_{A}Λβ_{A}^{†}, which means that communication unit B need not determine the unitary factor α.

In step 430, communication unit B factors the matrix defined by the received training signals (i.e., received from communication unit A) to determine power levels. Thus, communication unit B can uniquely factor Ψ^{†}X as Ψ^{†}X=\sqrt{T_{A}}\sqrt{Γ_{B}}β_{B}^{†}, where β_{B}≅β_{A} is unitary and Γ_{B}≅Γ=PΛ² is real nonnegative diagonal referred to, as described above, a diagonal power and singular value matrix. The communication unit B therefore can determine the unitary factor, β_{B} and the received power levels on each subchannel via Γ_{B}.

The method ends after step 430. The total training time for method 400 is about T_{A}+T_{B}≧2N.

An example of method 400 is now presented. Suppose M=4 and N=1. Then, H is a 4×1 matrix. In step 410, communication unit B sends communication unit A one training symbol: R=1. Thus, communication unit A receives Y=RH^{T}+V=H^{T}+V. The maximum likelihood (ML) estimate is then H_{A}=Y^{T}≅H (step 415).

Also in step 415, communication unit A performs an SVD: H_{A}=α_{A}Λ_{A}β_{A}^{†}, where α_{A}=H_{A}/∥H_{A}∥, β_{A}=1, and Λ_{A}=∥H_{A}∥. In step 420, communication unit A computes the optimal power levels. In this example, there is only one subchannel, therefore there is no water filling problem to solve.

In step 425, communication unit A sends one training symbol: A=α_{A}^{†}=H_{A}^{†}/∥H_{A}∥. Communication unit B receives the following: X=SH+W=H_{A}^{†}H/∥H_{A}∥+W≅∥H∥. In step 430, communication unit B estimates the following: Γ=∥X∥≅∥H∥ and β_{B}=X/∥X∥≅1.

In step 420 of method 400, it was assumed that communication unit A knew the actual receiver noise variance at communication unit B. In FIG. 5, a method 500 is shown for changing communication rates for two MIMO communication units communicating over a communication channel, in accordance with a preferred embodiment of the invention. Communication units A and B cooperate to perform method 500. Broadly, method 500 allows communication unit B to modify its training signals so that communication unit A, using an estimate of receiver noise variance at communication unit B, will change communication rates on the subchannels of the communication channel between communication units A and B.

In step 510, the communication unit A assumes a nominal receiver noise variance, σ₀². For instance, communication unit A could be programmed with, determine or estimate a lower bound on σ_{B}, such as σ_{B}²≧σ₀².

In step 515, the communication unit B, which also preferably is programmed with the nominal receiver noise variance, determines if actual receiver noise variance is greater than the nominal receiver noise variance. If not (step 515=NO), method 500 ends. If so (step 515=YES), the communication unit B sends scaled training signals to communication unit A. For instance, communication unit B can scale down the orthonormal training signals by a factor of σ₀/σ_{B}≦1 and use smaller power levels when transmitting the training signals. The scaled and lower power training signals cause, in step 525, communication unit A to lower communication rates for subchannels of the communication channel. Illustratively, communication unit A assumes that σ_{B}=σ₀. This assumption by communication unit A and the modification of training signals by communication unit B have the same effect as if communication unit A knows σ_{B}.

Thus, communication units A and B can assume receiver noise variance at communication unit B and communication unit B can indirectly modify the communication rates determined by communication unit A when communication unit B determines that actual receiver noise variance is higher than nominal.

In a conventional MIMO system, the communication unit A generally sets a communication rate for each of the subchannels on a communication channel between communication units A and B. Generally, the communication rates for each subchannel are transmitted from communication unit A to communication unit B. However, it is also desirable to have each communication unit decide on and implement a communication rate for each subchannel without the transmission of communication rates.

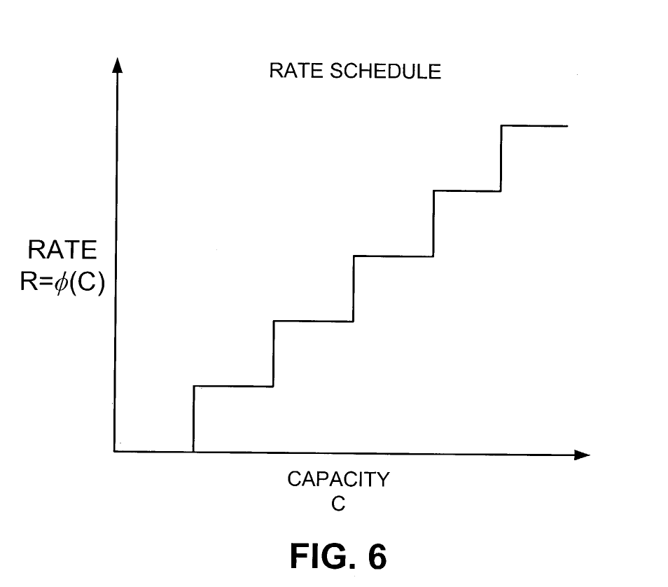

By way of illustration, a FIG. 6 shows a rate schedule, illustrated as a rate/capacity curve. Each communication unit A, B can have a copy of this rate/capacity curve. For example, in FIG. 3, the communication units 310, 370 store the rate schedules 312, 372.

Each communication unit A, B makes an estimate of subchannel capacity as follows:

Communication unit A: C_{An}=log(1+Pₙλ_{An}²/σ_{B}²)≅Cₙ

Communication unit B: C_{Bn}=log(1+γ_{Bn}²/σ_{B}²)≅Cₙ,

where γ_{Bn} is the received power on a subchannel. The capacities determined by communication unit A and communication unit B can differ somewhat.

Each of the communication units A, B use a quantizer to determine a communication rate for each subchannel. Communication unit A's communication rates are determined through R_{An}=φ(C_{An}), where φ(.) is a quantizer. Communication unit B's estimates of the communication rates are determined through R_{An}:R_{Bn}=φ(C_{Bn}). The quantizer can be a function, a table, a rate schedule, or any other technique for quantizing a capacity to determine a communication rate.

In the example of FIG. 6, communication unit A determines a capacity on a subchannel via the C_{An} formula given above. The communication rate is then determined from the rate schedule of FIG. 6. Similarly, communication unit B determines a capacity on a subchannel via the C_{Bn} formula given above, and the communication rate is then determined from the rate schedule of FIG. 6.

When communication unit A computes the capacities for the subchannels, communication unit A may find that a particular capacity for a subchannel may be near a discontinuity on the rate versus capacity schedule of FIG. 6. In this case, there is a possibility that communication unit B will choose the wrong rate. Under this circumstance, it is advantageous for communication unit A to adjust transmitted power on that subchannel, either increasing or decreasing the power on that subchannel. This moves the capacity away from the discontinuity and makes it more likely that communication unit B will infer the correct rate. The increase or decrease in power is taken into consideration when communication unit A determines powers via, for instance, the water filling rule.

Training and Scheduling for a One-to-Many MIMO Communication System

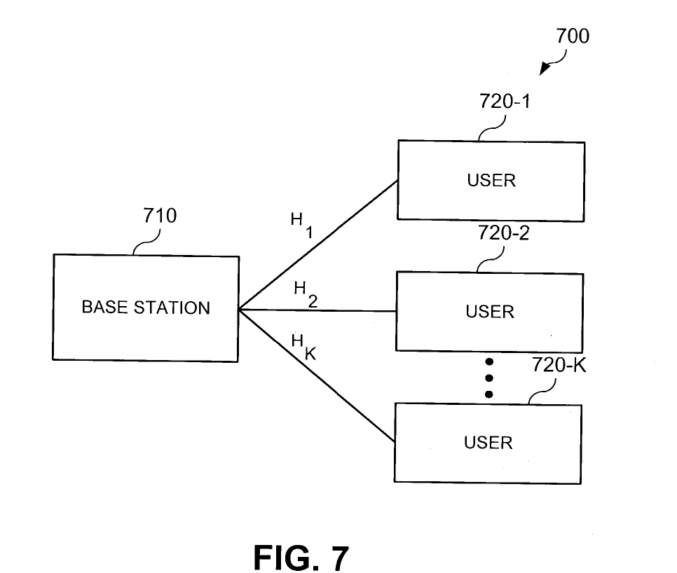

In doing one-to-many MIMO communications, there are a number of possible schemes that have been proposed. One scheme is presented here in terms of the present invention, but the present invention may be modified to include the other schemes. Referring now to FIG. 7, a one-to-many MIMO communication system 700 is shown. One-to-many communication system 700 comprises a base station 710 communicating with K users 720-1 through 720-K (collectively, users 720). The base station 710 has M antennas (not shown) and the k-th user has N_{K} antennas (not shown). Assume that M≧ΣₖNₖ. This assumption need not be made, but generally will be true for many communication systems.

The downlink model, from the base station 710 to the users 720, is as follows: Xₜ^{k}=SₜHₖ+Wₜ^{k}. The power constraint is as follows: E(SₜSₜ^{†})≦1.

The uplink model, from the users 720 to the base station 710, is as follows:

$${Y}_{t} = {\sum }_{k = 1}^{K} {R}_{t}^{k} {H}_{k}^{T} + {V}_{t} .$$

The power constraint is as follows: E(Rₜ^{k}Rₜ^{k}^{^{†}})≦1.

The following coding technique may be used:

$${S}_{t} {\sum }_{j = 1}^{K} {A}_{t}^{j} {G}_{j}$$

(superpostion),

where Aₜ^{k} is the 1×Nₖ message vector to user k and Gₖ is Nₖ×M such that there is no cross-talk: GⱼHₖ=0 if j≠k.

User k receives:

$$\begin{matrix}{X}_{t}^{k} = ( {\sum }_{j = 1}^{k} {A}_{t}^{j} {G}_{j} ) {H}_{k} + {W}_{t}^{k} , \\ = {A}_{k}^{t} {G}_{k} {H}_{k} + {W}_{t}^{k} .\end{matrix}$$

Suppose H=(H₁H₂ . . . H_{K}). Let the least-squares inverse E=(H^{†}H)⁻¹H^{†} be partitioned as E=(E₁^{T}E₂^{T} . . . E_{K}^{T})^{T} and let Eₖ=αₖΛₖβₖ^{†} be the SVD of E. For optimal encoding, maximum throughput is achieved by choosing

$${S}_{t} = {\sum }_{j = 1}^{K} {A}_{t}^{j} \sqrt{{\prod }_{j}} {β}_{j}^{†} ,$$

where {Πⱼ} is a nonnegative diagonal power matrix chosen by a water filling rule. The power constraint reduces to

$${\sum }_{k = 1}^{K} tr {\prod }_{k} = 1.$$

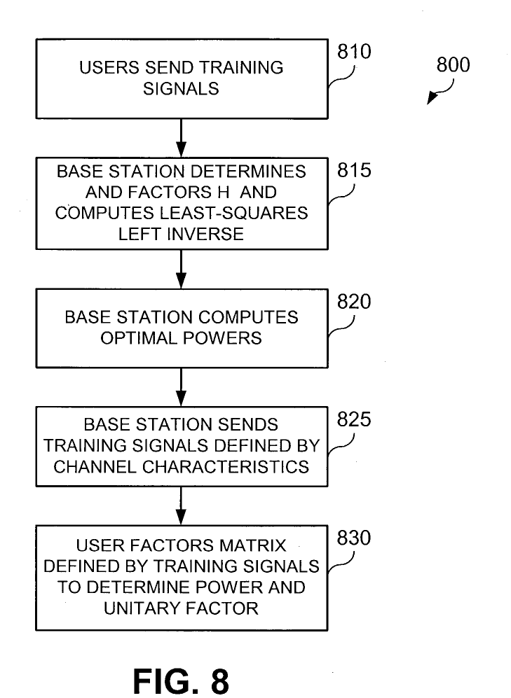

Referring now to FIG. 8, a method 800 is shown for training and scheduling between a base station 710 and multiple users 720, in accordance with a preferred embodiment of the invention. The base station 710 and users 720 cooperate to perform method 800.

In step 810, the users 720 send orthonormal training signals over Tᵤ≧ΣₖNₖ symbols on the uplink to the base station 710. The base station 710 computes estimates Ĥₖ≅Hₖ.

In step 815, the base station 710 computes the least-squares left inverse of Ĥ=(Ĥ₁ . . . Ĥ_{K}), i.e., Ê=(Ĥ^{†}Ĥ)⁻¹Ĥ and the SVDs: Êₖ=\hat{α}^{k}\hat{Λ}ₖ\hat{β}ₖ^{†}.

In step 820, the base station 710 computes the optimal powers, {Π}ₖ, using a water filling rule, described above.

In step 825, on the downlink, the base station 710 sends training signals, S=\sqrt{T_{D}}Σᵢ₌₁^{k}Ψⱼ\sqrt{Πⱼ}\hat{β}ⱼ^{†}, where T_{D}≧ΣₖNₖ, Ψₖ is T_{D}×Nₖ, where optional factor Ψₖ increases the training time duration to improve training effectiveness. Then, user k receives:

$${X}^{k} = {SH}_{k} = {\sum }_{j = 1}^{K} \sqrt{{T}_{D }} {Ψ}_{j} \sqrt{{\prod }_{j}} {\hat{β}}_{j}^{†} {H}_{k} + {W}^{k} ,$$

[symbol]

Ψₖ^{†}X^{k}=\sqrt{T_{D}}\sqrt{Πₖ}Λₖ⁻¹αₖ^{†}+noise terms.

It should be noted that

$$\frac{1}{{T}_{D}} E tr ( {SS}^{†} ) = {\sum }_{k} tr {\prod }_{k} = 1 ,$$

which means that the power constraint is met.

In step 830, a user k of the users 720 can now estimate \hat{α}ₖ and Γₖ=ΠₖΛₖ⁻¹, whose diagonal entries are the received signal power levels on the subchannels to user k. User k now has all the knowledge needed to decode messages transmitted by base station 710. In this technique, the users 720 are not doing anything more than in the one-to-one MIMO communication system described previously.

The total training time in this exemplary embodiment is approximately Tᵤ+T_{D}≧2ΣₖNₖ.

It is to be understood that the embodiments and variations shown and described herein are merely illustrative of the principles of this invention and that various modifications may be implemented by those skilled in the art without departing from the scope and spirit of the invention. Generally, the training signals sent from a first communication unit to one additional communication unit are defined in part by channel characteristics corresponding to power levels to be used when transmitting over subchannels and by the unitary factor of the first communication unit. Either the power or the unitary factor may be used when defining the training signals. As another illustration, the examples given herein used M≧N for antennas, but the examples may be modified by those skilled in the art for the case of M<N. It can be shown that the training technique described can be used most effectively if the roles of communication unit A and communication unit B are reversed. In this case, the amount of training T_{A}+T_{B}≧2M. Therefore, for whatever the number of antennas, training can be accomplished such that T_{A}+T_{B}≧2 min(M, N).

The preceding discussion assumed that a condition of flat-fading holds, such that the frequency response of the channel is substantially constant over the bandwidth of the transmitted signals. This is termed a “narrow band” channel herein. It is possible that this condition will be violated when there is some combination of propagation conditions (e.g., long delay-spread, and high bandwidth) causing it to be violated. In that case (called a “wide-band” channel herein), it is possible to divide the high-bandwidth channel into a multiplicity of parallel channels of narrower bandwidth, occupying nonoverlapping intervals of frequency, such that each of these narrow band channels satisfies the flat-fading condition. Then the invention described previously can be applied independently to each of the narrow band channels. The well known technique of Orthogonal Frequency Division Multiplex (OFDM) is particularly convenient for rendering the wideband channel into a multiplicity of narrow band channels.

In some cases, the communication unit B may experience interference from other transmissions than that of communication unit A, such that the interference has significant correlation among the receive antennas of communication unit B. This condition can be handled as follows. First, communication unit B measures the covariance of his own receiver noise in combination with the interference, during an interval when communication unit A is not transmitting. Communication unit B can then take the square-root of this covariance matrix, and apply its inverse (e.g., a whitening matrix) to his received signals, which will render the combination of interference and noise uncorrelated. Communication unit B now treats the product of the channel propagation matrix and the whitening matrix as one composite propagation matrix. When communication unit B transmits the initial orthonorinal training signals to communication unit A, communication unit B multiplies the orthonormal training signals by the whitening matrix prior to transmission. Then the propagation matrix that communication unit A receives is the composite propagation matrix. All remaining steps proceed as before, since communication unit A only needs to know the composite propagation matrix.

The preceding discussion assumes that a purpose of training is to enable communication unit A to transmit messages to communication unit B. A simple modification to the training enables communication unit B to transmit to communication unit A as well as communication unit A to communication unit B. The training that communication unit A sends to communication unit B is modified by eliminating the diagonal power matrix, \sqrt{P}. The training signal that communication unit B receives, when factored by communication unit B, gives communication unit B both the unitary factor, and the diagonal matrix of singular values. Assume that communication unit B knows the available power budget by communication unit A. Then communication unit B can duplicate the prior calculation by communication unit A of optimal water filling powers, and, through the rate/capacity schedule, the rates that communication unit A is employing. While the rates that communication unit B infers may differ, because of noise effects, from those that communication unit A is using, a way of determining rates in the face of noise is given below. Communication unit B now has the information needed to decode the messages that communication unit A transmits. Also, communication unit B has the information, assuming that communication unit B knows the receiver noise variance of communication unit A, to transmit messages to communication unit A.

Regardless of the technique used for communication unit A and communication unit B to determine transmission rates, there may be a discrepancy between the rates determined by communication units A and B. It is still possible for the unit that is receiving the message to infer the correct rate adaptively from the modulation employed in sending the message, since, in general, each rate is associated with a unique modulation and coding scheme.

The various assumptions made herein are for the purposes of simplicity and clarity of illustration, and should not be construed as requirements of the present invention.

We claim:

1. In a multiple input, multiple output (MIMO) communication system, a method for performing training to characterize one or more communication channels between a first communication unit and one or more additional communication units, comprising the steps of:
determining in the first communication unit one or more channel characteristics by using a plurality of first training signals received by the first communication unit from one of the additional communication units;
determining in the first communication unit a plurality of second training signals defined at least in part by the one or more channel characteristics; and
transmitting the plurality of second training signals from the first communication unit to the one additional communication unit.

2. The method of claim 1, wherein the first communication unit is adapted to transmit and receive using at least two antennas, and wherein at least the one additional communication unit of the one or more additional communication units is adapted to transmit and receive using at least two antennas.

3. The method of claim 1, wherein the first communication unit and at least the one additional communication unit of the one or more additional communication units are each adapted to transmit and receive using one or more antennas.

4. The method of claim 1, wherein the first communication unit is adapted to transmit and receive over a first number of antennas, the one additional communication unit is adapted to transmit and receive over a second number of antennas, and wherein the first number of antennas is greater than or equal to the second number of antennas.

5. The method of claim 1, wherein the one additional communication unit is adapted to transmit and receive over a first number of antennas, the first communication unit is adapted to transmit and receive over a second number of antennas, and wherein the first number of antennas is greater than the second number of antennas.

6. The method of claim 1, wherein the step of determining one or more channel characteristics further comprises the step of determining a unitary factor from a matrix defined at least in part by the plurality of first training signals, and wherein the step of determining a plurality of second training signals comprises the step of determining a plurality of second training signals defined at least in part by a complex conjugate transpose of the unitary factor.

7. The method of claim 1, further comprising the step of the first communication unit determining a plurality of power levels suitable for use when transmitting on a plurality of subchannels defined by a communication channel between the first communication unit and the one additional communication unit.

8. The method of claim 7, wherein the step of determining a plurality of second training signals comprises the step of determining a plurality of second training signals defined at least in part by the plurality of power levels.

9. The method of claim 7, wherein the step of determining a plurality of power levels further comprises the step of determining, by using a water filling rule, a plurality of power levels suitable for use when transmitting on a plurality of subchannels defined by a communication channel between the first communication unit and the one additional communication unit.

10. The method of claim 9, wherein the step of determining, by using a water filling rule, a plurality of power levels is performed using a nominal noise variance for the one additional communication unit.

11. The method of claim 1, further comprising the step of receiving the plurality of first training signals, and wherein the plurality of first training signals are received at a first carrier frequency, the second training signals are transmitted at a second carrier frequency, and wherein a difference between the first and second carrier frequencies is less than a reciprocal of a delay-spread of one of the one or more channels over which the first and additional communication units are communicating.

12. The method of claim 1, wherein one of the one or more channels over which the first and additional communication units are communicating is a wide-band channel and wherein the method further comprises the steps of:
partitioning the wide-band channel into a multiplicity of narrow band channels;
selecting a narrow band channel; and
performing, for the selected narrow band channel, the steps of determining in the first communication unit one or more channel characteristics, determining in the first communication unit a plurality of second training signals, and transmitting.

13. The method of claim 1, wherein the step of determining a plurality of second training signals further comprises the step of:
performing a singular value decomposition of a channel propagation matrix defined at least in part by the plurality of first training signals.

14. The method of claim 2, further comprising the steps of:
determining a capacity for at least one of a plurality of subchannels defined by a communication channel between the two or more antennas of the first communication unit and the two or more antennas of the one additional communication unit; and
determining a communication rate for the at least one subchannel by quantizing the capacity.

15. The method of claim 14, wherein the step of determining a communication rate further comprises the step of determining that a communication rate is near a discontinuity on a rate schedule used to quantize the capacity, and wherein the method further comprises the step of reducing or increasing power used to transmit on the at least one subchannel, thereby moving the communication rate away from the discontinuity.

16. The method of claim 2, wherein another of the additional communication units is adapted to transmit and receive using at least two antennas, and wherein the method further comprises the steps of:
determining an additional one or more channel characteristics by using a plurality of additional training signals received by the first communication unit from the other additional communication unit;
determining a plurality of second training signals defined at least in part by the additional one or more channel characteristics; and
transmitting the plurality of second training signals from the first communication unit to the other additional communication unit by using the at least two antennas of the first communication unit.

17. In a multiple input, multiple output (MIMO) communication system, a method for performing training to characterize one or more communication channels between a first communication unit and one or more additional communication units, comprising the steps of:
transmitting a plurality of first training signals from one of the one or more additional communication units to the first communication unit; and
receiving at the one additional communication unit a plurality of second training signals transmitted by the first communication unit and defined at least in part by one or more channel characteristics determined by the first communication unit by using at least the first training signals.

18. The method of claim 17, wherein the first communication unit is adapted to transmit and receive using at least two antennas, and wherein at least the one additional communication unit of the one or more additional communication units is adapted to transmit and receive using at least two antennas.

19. The method of claim 18, further comprising the step of factoring, at the one additional communication unit, a matrix defined at least in part by the plurality of second training signals, the step of factoring determining one or more terms.

20. The method of claim 19, wherein at least one term of the one or more terms defines at least one received power level from at least one of a plurality of subchannels defined by a communication channel between the first communication unit and the one additional communication unit.

21. The method of claim 17, wherein a communication channel between the first communication unit and the one additional communication unit comprises a plurality of subchannels, each of the subchannels corresponding to a subset of the two or more antennas of the one additional communication unit.

22. The method of claim 17, wherein the one or more second training signals are defined at least in part by one or more channel characteristics as determined by the one additional communication unit.

23. The method of claim 18, further comprising the step of transmitting on the at least one antenna of the one additional communication unit using the power level determined from the at least one term.

24. The method of claim 18, further comprising the steps of:
determining a capacity for at least one of a plurality of subchannels defined by communication between the two or more antennas of the first communication unit and the two or more antennas of the one additional communication units; and
determining a communication rate for the at least one subchannel by quantizing the capacity.

25. The method of claim 17, further comprising the steps of:
determining that an actual noise variance corresponding to the one additional communication unit is greater than a nominal noise variance;
modifying a plurality of training signals, where the training signals before modification have predetermined properties known to the first communication unit; and
transmitting the plurality of modified training signals on the at least two antennas coupled to the second communication unit.

26. The method of claim 25, wherein the step of modifying further comprises the step of scaling the plurality of training signals by the nominal noise variance divided by the actual noise variance.

27. The method of claim 25, wherein the step of modifying further comprises the step of reducing power levels used to transmit the plurality of training signals.

28. The method of claim 19, wherein the step of factoring further determines a unitary factor.

29. The method of claim 17, wherein the plurality of second training signals are defined at least in part by power levels determined by the first communication unit for a plurality of subchannels defined by a communication channel between the first communication unit and the one additional communication unit, and wherein the second training signals are defined at least in part by a unitary factor determined by the first communication unit.

30. A communication unit for use in a multiple input, multiple output (MIMO) communication system and for performing training to characterize one or more communication channels between the communication unit and one or more additional communication units, comprising:
receive circuitry adapted to receive by using a plurality of antennas coupled to the communication unit a plurality of first training signals from the one additional communication unit;
training circuitry coupled to the receive circuitry and adapted to:
determine one or more channel characteristics by using the plurality of first training signals; and
determine a plurality of second training signals defined at least in part by the one or more channel characteristics; and
transmit circuitry coupled to the training circuitry and to the plurality of antennas and adapted to transmit the plurality of second training signals over the plurality of antennas to the one additional communication unit.

31. A communication unit for use in a multiple input, multiple output (MIMO) communication system and for performing training to characterize one or more communication channels between a first communication unit and one or more additional communication units of which the communication unit is one of the one or more additional communication units, comprising:
transmit circuitry coupled to a plurality of antennas coupled to the communication unit, the transmit circuitry adapted to transmit a plurality of first training signals from the communication unit to the first communication unit; and
receive circuitry coupled to the plurality of antennas and adapted to receive a plurality of second training signals transmitted by the first communication unit, wherein the second training signals are defined at least in part by one or more channel characteristics determined by the first communication unit by using at least the first training signals.
